(19) United States
(12) Patent Application Publication
(10) Pub. No.: US 2005/0266129 A1
(43) Pub. Date: Dec. 1, 2005

(54) Packaging material and method for perishable food product

(76) Inventor: Nazir Mir, North Brunswick, NJ (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 10/855,305

(22) Filed: May 27, 2004

(51) Int. Cl. C12H 1/10

(52) U.S. Cl. 426/415

(57) ABSTRACT

A cost-effective packaging and preservation process for initiating and controlling the ripening rates of a perishable food product, and more particularly, banana fruit, having different maturity stages followed by uniform ripening, good internal and external fruit quality and normal development of flavor and aroma characteristics. A polymeric perforated package is provided which controls the atmosphere within the package as the fruit progresses through its ripening stages so as to not appreciably delay ripening to an intermediate ripening stage, but to delay ripening, and thus shelf life, of the food product beyond such intermediate ripening stage.

### BACKGROUND OF THE INVENTION

1. FIELD OF THE INVENTION

This invention relates to packaging and methods of packaging perishable food products, and more particularly to a package and packaging method for extending the shelf life of perishable food products, and even more particularly, bananas.

2. BACKGROUND OF THE PRIOR ART

Tropical fruits, such as bananas, are grown largely in developing countries, harvested at their mature green stage (color stage 1-1.5), packed in 40 lb. cardboard boxes, and then transported in temperature controlled ships thousands of miles around the Atlantic and Pacific oceans before reaching the consumption markets of the United States, United Kingdom, Japan, and other emerging Far East markets.

Once the fruit arrives in the destination market, it is typically artificially ripened in temperature controlled commercial ripening rooms (still in cardboard boxes) with exogenous application of a ripening hormone, ethylene. Depending on the temperature of the ripening room (56 to 64° F.), ripening to color stage 3.5 can take 4 to 6 days. Super market chains and food service outlets then typically purchase banana fruits from distributors once the fruit has reached color stage 3.5.

The fruit is typically pulled out of the 40 lb. cardboard boxes and displayed on supermarket shelves at or post color stage 3.5. Interestingly, the further progression of banana fruit ripening is quick and in most cases it takes only 2 to 3 days to reach color stage 7. The fruit at color stage 7 has well-developed sugar spots and market tolerance to such fruits is zero. Thus, the marketing window for supermarkets is typically only 2 to 3 days. Because of the resulting short market life of bananas, supermarkets are constantly advertising marketing promotions to minimize fruit losses at the supermarket level.

While supermarkets on the one hand want to move the banana fruit quickly out of their store, consumers on the other hand are not eager to purchase any additional fruit quantities beyond their two to three day fruit needs. Consumers often handpick fruits that they perceive will last for at least a few days. They physically color sort and pick the fruits and in doing so some damage to the fruit is induced by customers. This leads to around 10% shrinkage at supermarket level.

Consumers often purchase from four to ten fruit in a single hand, all of which ripen simultaneously. Very often, only one or two fruit are consumed at the consumer's preferred stage of ripeness. Bananas commonly become overripe and are eaten at this lower level of quality or are often discarded or directed into a use other than fresh consumption (e.g., purees or baked products). Although preservation post color stage 3.5 continues to be the problem, consumers demand high quality bananas in the marketplace.

Supermarkets have evolved to play a dominant role in meeting consumer expectations. They recognize that one of the ways to reduce shrinkage at the supermarket level is to offer bananas in 1 to 3 lb. consumer packages. This concept has completely evolved in the European markets and the need for packaged fruit in the United States is growing. Currently, approximately 10% of the total United States market demand is sold in 3 lb. packages. In some instances, due to the high respiration needs of banana, currently used packages are macro perforated (sixteen to twenty 1 cm diameter holes/package) and do not offer any quality protection or extension of shelf life.

There is a commercial interest in extending and preserving the market preferred yellow life of bananas. Extension of green life of bananas by use of controlled atmosphere (Mapson and Robinson, 1966, McGlasson and Wills, 1972; Madrid and Lopez-Lee, 1998) or modified atmosphere (Mapson and Robinson, 1967; Burg, 1975; Yahia, 1997) has been achieved to some extent. However, these technologies may lead to alteration of ripening characteristics of banana fruit that may lead to dull yellow color and slow ripening in air. In addition, the delayed ripening to color stage 3.5 is significantly increased such that fruit ripening is difficult to manage at the commercial level.

Further, U.S. Patent Application Number 2002/0127305 A1 uses a porous patch consisting of side-chain-crystallizable acrylic polymers for storage and ripening of green bananas. The polymer is designed to undergo a phase transition; the polymer molecules shift from a somewhat ordered, more crystalline state (less permeable) to a more amorphous state (more permeable) as the temperature rises. Thus, the patch made up of this special polymer is the major route for gas flow in and out of the package. The physical properties of these polymers are such that they are not suitable as packaging material but rather are suited as patches applied to packages. In order for this technology to work for the banana industry, one must drill the hole on the bag and apply the breathable patch over the hole before the fruit is packed in such an invention. These extra steps reduce the pack-out speed that directly translates to the higher packing cost per unit of packed fruit. In addition, this technology is very expensive.

U.S. Pat. No. 6,190,710 B1 describes a method of preserving produce utilizing special polymers such as XTEND® (StePac L.A. Ltd., Israel) that are designed to facilitate moisture loss to minimize condensation and decay development. These films are based on copolymers of polyester and polythene, which have the advantage of high transmission of water vapor, thus enabling the humidity to diffuse out of the package before the water droplet is formed. However, the permeance of the film to oxygen is too low, such that the film needs to be perforated in order to prevent anaerobiosis and the production of off-flavors by the product. The authors used special polymer bags in conjunction with relatively large perforations of 600μ diameter to prevent decay of 12 kilogram banana bunches. The specialized polymers used to achieve decay control are, again, very expensive.

Compared to other tropical fruits, the quality standards for marketing of bananas are relatively high. One of the drivers of banana sales is their good appearance. An attractive, bright and clean display of high quality, blemish-free and well-colored fruit promotes sales. Display of green or bruised bananas is viewed as a significant detraction by supermarket chains. Unfortunately, most of the currently available technologies including sealed non-perforated and perforated polymeric packages do interfere with the display quality of banana fruit.

The general dogma of extending storability by modified atmospheric packaging (“MAP”) is that storability will improve in response to low O₂ package atmospheres. However, it is important to recognize that while low O₂ atmospheres can improve storability of some fruits and vegetables, it has the potential to induce undesirable effects as well. If O₂ levels decline below concentrations required to sustain aerobic respiration, fermentation and off-flavors may result (Kays, 1997; Richardson and Kosittrakun 1995). Risks include not only the loss of product quality through fermentative metabolism, but also the growth of potential human pathogens that thrive under anaerobic conditions (Hintlian and Hotchkiss, 1986; Nguyen-the and Carlin, 1994). In addition, fermentation can lead to development of CO₂ concentrations exceeding a level tolerated by the plant tissues and thereby causing injury to the plant tissue. Tolerance limits for O₂ and CO₂ for bananas are above 2% O₂ and below 7% CO₂. Surprisingly, for bananas, it has been discovered that the tolerance limits to CO₂ increased to 20% if the package O₂ increased to 6%. Incorporation of high CO₂ in the packaging not only protects the product quality but also suppresses the microbial growth and development.

### SUMMARY OF THE INVENTION

The present invention relates to controlling the rate of ripening of climacteric fruits, such as bananas, to extend the shelf life during transit, distribution, marketing, and/or consumption. With regard to a first aspect of the invention, microperforated packaging is provided that creates package environments (CO₂, O₂, ripening agent, and H₂O Vapor) that interact in a synergistic fashion to maintain the quality of fruit at the desired maturity stage and to insure that when the ripening progresses, all of the desired sensory attributes develop as expected. This helps to increase the utility and quality of high-respiring and climacteric fruits (i.e., fruits that produce and respond to a ripening-related gas, such as the ripening hormone ethylene) by allowing the distributors to initiate ripening and control ripening with improved quality during transport, distribution, marketing, and/or consumption. This also helps the banana industry increase the product offerings of bananas to the retail and food service outlets by extending the shelf life of different maturity bananas, potentially all but more specifically those within the color range of 3-7.

With regard to another aspect of the invention, a process is disclosed of packaging perishable food product, and in a particularly preferred embodiment, bananas, in which O₂, CO₂, ripening agent (e.g., ethylene), and moisture within a package modulate ripening and storability of the food product. Package atmospheres comprising high levels of CO₂ and H₂O vapor, and moderate levels of O₂ and C₂H₄ (or other ripening agents) provide useful synergy in the extension of banana shelf life of all color stages and retention of quality attributes during distribution, marketing, and/or consumption. While the examples set out below particularly reference the use of ethylene as the ripening agent, it should be noted that appropriate ripening agents may also include analogs of ethylene, such as (by way of example) propylene.

The packaging and method of packaging comprising the invention herein provide a cost effective quality preservation process for packing, handling, ripening, distribution, marketing, and/or consumption of banana fruit. More particularly, the packaging and method of packaging pursuant to the preferred embodiments of the instant invention set forth herein provide for the preservation of perishable food product, and more particularly bananas, by recognizing and accounting for the commercial importance of color stage 3.5 in the ripening protocol and the need to further preserve the marketable (color stage 3.5-6.0) and consumer-preferred eating quality (color stage 5.0-6.5). Microperforated packaging is used to create package environments that do not appreciably delay ripening to color stage 3.5, but that significantly delay ripening post color stage 3.5 for commercial needs, while maintaining highly uniform color and sensory attributes of the fruit, and delaying and even inhibiting the onset of sugar spot development.

The packaging and method of packaging of the instant invention allow the use of a low cost polyethylene bag, and do not interfere with the established protocols of packing, transport, ripening, distribution, and marketing protocols for bananas. In addition, the packaging and method of packaging of the instant invention extends yellow life, maintains peel integrity, delays onset of sugar spots, and/or inhibits considerably further progression of sugar spot development.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a graphical representation of the effect of the invention on a 4 day ripening of perishable food products.

FIG. 2 is a graphical representation of the effect of the invention on a 4 day ripening followed by 5 day storage of perishable food products.

FIG. 3 is a photograph comparing the physical state of food product that had been packaged according to the invention in contrast to the same food product that had been packaged via conventional means.

### DETAILED DESCRIPTION OF THE PREFERRED EMBODIMENTS

The invention summarized above may be better understood by referring to the following description, which should be read in conjunction with the accompanying drawings. This description of embodiments, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The packaging and method of the instant invention, pursuant to a first preferred embodiment thereof, are based upon the inventor's discovery that (i) tolerance to CO₂ by banana tissue can be improved by increasing internal O₂, and more particularly by maintaining the preferred ratios of CO₂ to O₂ in the range of 2.5:1 to 3.5:1, which discovery evolves to the concept of using high CO₂ and improved levels of O₂ for distribution and storability of fruits and vegetables; and (ii) within the above described limits of CO₂ and O₂ as defined above, water vapor (RH>70%) and ethylene (>100 ppm) interact in a synergistic fashion to confer additional quality protection and shelf life.

In a preferred embodiment, micro-perforation technology (e.g. proper selection of base sheet, hole size, hole shape, hole number and hole positioning) can be conveniently and reliably used to achieve target atmospheres of O₂, CO₂, water vapor and ethylene. Thus, it is conceivable that the base film could consist of a number of polymer groups such as polyalkenes (e.g., polyethylene—low and ultra low density, linear low density, high density, etc.), polyvinyls (e.g., polypropylene, oriented polypropylene), polystyrenes (e.g., polyvinyl chloride), polysiloxanes (e.g., silicone rubber), polydiens (e.g., natural rubber), and laminates of the foregoing, as well as metallocene films and coextruded films, all with or without antifog agents. The base film can be extruded from a single polymer or blends of various polymers where each polymer performs a specific function, such as contributing strength, transparency, sealability, or machineability, to meet specific product requirements. Similarly, films can be laminated to achieve specific properties. Other methods of creating these environments during distribution and marketing may include the use of other modified atmosphere and/or controlled atmosphere technologies.

In a particularly preferred embodiment of the invention, an inexpensive polyethylene bag is used for all or one of the purposes of packaging, transport, ripening, distribution, marketing and yellow life extension of banana fruit. The bag may be custom tailored for individual bananas or packages of, for example, 1 to 40 lbs. The fruit may be packaged in hands consisting of 4 to 10 bananas per hand or in packages consisting of individual fingers. For instance, this invention was successfully tested for standard 2.5 to 3.5 lb. bags having fruit in clusters for supermarket and food service distribution, and for 2.5 to 3.5 lb. bags consisting of 8 single fingers/bag for food service distribution. The bag for these two applications consisted of low density polyethylene having a size of 17″×12″, thickness of 1 mil and 44 perforations of 100μ size.

Using polymeric films of differing permeabilities, modified atmospheric packaging systems for products with low to medium respiration rates have been developed with varying degrees of success. One previously known technology has been film packaging for leafy greens. However, banana fruit exhibit a much higher rate of respiration, such that conventional solid (i.e., no holes) film will over-modify the headspace atmosphere resulting in fermentation. Additionally, moisture control is considered equally essential to preserve the peel health and thereby the appearance of the banana fruit. To overcome these problems, it is best to design a perforated film with a combination of hole size and density that allows the fruit to achieve the desired atmosphere without fermentation and to maintain sufficient moisture for the achievement of optimum quality and extended shelf life of the ripening fruit. As explained above, a polymeric film (e.g. LDPE, LLDPE, HDPE, OPP COPP, laminates of different polymers) is selected as the base sheet, LDPE being preferred. Size and number of the perforations are determined based on the weight (bananas) to surface area (film) ratio, the respiration rate of the bananas, and the shelf life requirements. Diameter of the perforations can be in the range of 5-500μ, and preferably have a mean diameter of 100-130μ. The density of holes in the film will be determined by the above mentioned parameters but will generally be in the range of 11-100 holes per pound of bananas depending on the required open area and the base sheet gas transmission properties. Since percentage of open area is important, there is an interaction between hole size and hole density. In general, better and more uniform results are achieved with small holes and higher number of holes. The base sheet, hole size and hole number are selected to achieve package atmospheres during the later portion of storage that comprise O₂ levels in the range of <10%, CO₂ levels in the range of 5-20%, and RH of >70%. Microperforations may be made using a number of methods known to those skilled in the art, including but not limited to laser perforation.

With regard to another aspect of the invention, a preferred embodiment utilizing the packaging method of the instant invention consists of the following steps:

(1) Enclosing the green fruit at color stage 1 to 2 in micro-perforated bags in their country of origin, the atmospheric composition within the bag being approximately ambient atmosphere.

(2) Packaging the enclosed fruit in standard corrugated containers and packing the corrugated containers in refrigerated sea containers for shipment to their destination. Depending on the destination, transportation times can vary from 5 days to more than 21 days. During transit and arrival at the destination, the atmospheric composition within the sealed bags is preferably maintained at >10% O₂ and <10% CO₂.

(3) Ripening the bananas with exogenous application of >100 ppm ethylene at 56 to 64° F. through standard corrugated box and inner sealed bag to the preferred distribution color stage of 3.0 to 3.5. At this preferred distribution color stage, the atmospheric composition within the sealed bags is preferably maintained at >5% O₂ and <12% CO₂.

(4) Distributing the bananas to retail and food service outlets post color stage 3.5. The atmospheric composition of the bag during supermarket or food service display is preferably maintained at >2% O₂ and >5% CO₂, and more preferably >10% CO₂. Alternatively, the bags can be opened and fruit sold as loose fruit at the supermarket level.

Notably, the invention set forth herein is likewise useful for applications which utilize “active packaging,” i.e., where the fruit is initially sealed in the package in an environment having predetermined levels of O₂, CO₂, and N₂.

Thus, the bananas are packed in bags according to the first aspect of the invention at air atmospheres in the producing country, transported to the port of destination and ripened to the desired supermarket color stage of 3.5 to 4 via conventional exposure to ethylene through the bag. The respiration rate of the banana fruit is slow in green and earlier states of ripening (color stage <3.5), and it increases approximately 5-fold post color stage 3.5. The increased demand for respiratory O₂ post color stage 3.5, coupled with the appropriate design of microperforations (hole size and density, positioning, etc.) makes the package and method of packaging set forth herein particularly useful for bananas. The slow rate of respiration in green and earlier stages of ripening helps to keep the O₂ high enough (>5%) and CO₂ low enough (<12%) such that no appreciable delay to color stage 3.5 occurs. Once the respiration rate post color stage 3.5 starts increasing rapidly, the package O₂ declines and CO₂ increases such that further progression of ripening is delayed and shelf life extended for commercial needs. Using such package and method of packaging in accordance with the instant invention, the yellow life of the banana fruit so packaged is extended in the desired eating range, preferably to 5-6 days.

### EXAMPLES

### Example 1.

In Example 1, the effect of various combinations of package O₂ and CO₂ on peel blackening and storability of the banana fruit was studied. Bags 12 inches wide and 17.7 inches long were made from microperforated monolayer styrene butadiene (XC) film. Perforations were sized at 120μ in diameter (for Treatments 1 through 3 in Table 1) and 1000μ in diameter (for Treatment 4). The number of holes per unit of film area (424.8 square inches) for 3 pounds of bananas was adjusted as follows:

1. 10 holes of 120μ size/bag

2. 30 holes of 120μ size/bag

3. 42 holes of 120μ size/bag

4. 30 holes of 1000μ size/bag

Fruit at color stage 4 was heat sealed into these bags and further progression of fruit ripening and senescence was studied for a 7 day holding period at 20° C. From this study, one will note that with O₂ levels achieved in treatments 2 and 3 (4.3% and 5.7%) in combination with 14.5 to 15% CO₂, an increase of 3 days in shelf life extension was achieved (Table 1, comparing Treatments 2 and 3 with Treatment 4). In contrast, in Treatment 1, where the internal package O₂ was 2.2% and CO₂ was 19%, an extension in shelf life of 1 day was achieved (Table 1, comparing Treatment 1 with Treatment 4). The termination of shelf life in this treatment was due to peel blackening on day 4 of holding. When the fruit was packed in bags of Treatment 1 and CO₂ levels were maintained at approximately 0.5% by using CO₂ absorbing material, peel blackening was completely eliminated. This suggested that peel blackening in banana is induced by accumulation of high CO2 in the package atmosphere. Surprisingly, peel blackening of banana fruit can also be avoided if the package O₂ and CO₂ atmospheres are in the ratio of 2.5 to 3.5 (Table 1, Treatments 2 and 3). This leads to extension in shelf life by 3 additional days (Table 1, comparing Treatments 2 and 3 with Treatment 4).

TABLE 1
Effect of internal package O₂ and CO₂ achieved by package
perforation on shelf life, visual quality (peel blackening and sugar spots) and internal
quality (firmness, brix, taste, and flavor) of banana fruit packaged at color stage 4.

| | ¹O₂ | ¹CO₂ | Shelf life | | |
|---|---|---|---|---|---|
| Treatment | (%) | (%) | (days) | ²Visual | ²Internal |
| 1 | 2.2 | 19.0 | 4 | 90% yellow with green tips, | Very Soft texture, Firnmess of |
| 10 holes of | | | | Severe Peel Blackening | 0.85 Lbs, Brix reading of 18, Pulp |
| 120 μ size | | | | (PB) on all fruits, Very few | appeared 1 color stage more |
| | | | | sugar spots (SS) but fruits | advanced in ripeness than Peel. |
| | | | | unacceptable due to PB on | Fruits had ethyl acetate note in |
| | | | | day 4 of holding. | taste. |
| 2 | 4.3 | 15.0 | 6 | 100% yellow, No Peel | Firm texture, Firmness of 1.20 |
| 30 holes of | | | | Blackening, 50% fruits had | Lbs, Brix reading of 21, Pulp |
| 120 μ size | | | | SS. The SS very small in | appeared 0.5 color stage more |
| | | | | size. Fruits acceptable on | advanced in ripeness than Peel. |
| | | | | day 6. | Fruits had normal banana flavor. |
| 3 | 5.7 | 14.5 | 6 | 100% yellow, No Peel | Firm texture, Firmness of 1.15 |
| 42 holes of | | | | Blackening, 70% fruits had | Lbs, Brix reading of 21.1, Pulp |
| 120 μ size | | | | SS. The SS very small in | appeared 0.5 color stage more |
| | | | | size. Fruits acceptable on | advanced in ripeness than Peel. |
| | | | | day 6. | Fruits had normal taste. |
| 4 | 18.5 | 3.5 | 3 | 100% yellow, No PB. SS | Moderate texture, Firmness of |
| 30 holes of | | | | observed on day 3 on 90% | 0.95 Lbs, Brix reading of 21, Pulp |
| 1000 μ size | | | | fruits. Fruits unacceptable | appeared 0.5 color stage more |
| | | | | on day 3 due to large size | advanced in ripeness than Peel. |
| | | | | and frequency of SS. | Fruits had normal banana taste. |

¹Package O₂/CO₂ data is at day 4 of holding.
²The subjective analysis for internal quality was performed at the termination of shelf life. Termination of Shelf Life was determined either by visual appearance of sugar spots (Treatments 2, 3 and 4) or visual appearance of peel blackening (Treatment 1).

### Example 2.

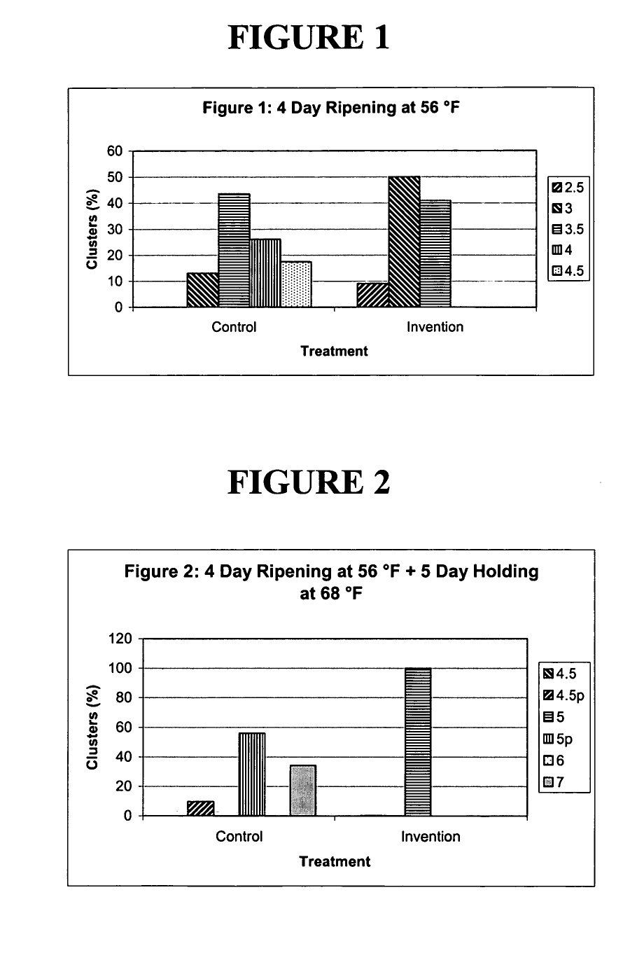

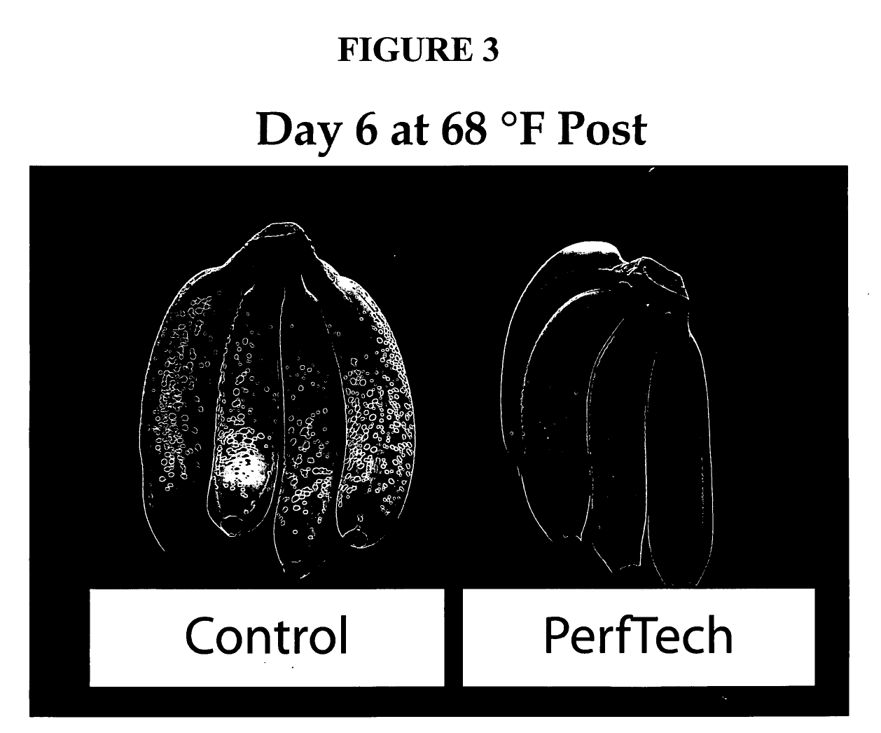

In Example 2, the effect of a microperforated LDPE bag on ripening to color stage 3.5 at 56° F. in a standard ripening room and subsequent color progression at 68° F. FIGS. 1 and 2) was evaluated.

As shown in FIG. 1, a ripening scale of 1 to 7 (where 1 is complete green, 7 is full yellow with onset of sugar spots, and the remaining stages represent increase in yellowness with increase in color stage) was used for evaluating the color progression of fruits. Notably, 90% of the fruits packaged in a microperforated bag in accordance with the invention herein reached color stage 3-3.5 on day 4 of ripening. This evidences the fact the package and method of the instant invention does not lead to any commercially measurable delay to supermarket-preferred color stages.

Likewise, as shown in FIG. 2, use of the package and method according to the invention leads to highly uniform color, as evidenced by the fact that all fruit packaged according to the invention exhibited color stage 5 at day 4. In contrast, the fruits in the control bags had fruit at a broad range of color stages (color stage 4.5p through 5p). Notably, the control fruits developed sugar spots in earlier stages of ripening denoted by 4.5p and 5p. Normally, the color progresses to color stage 6.5 and at that point sugar spots develop. The package and method of the instant invention lead to normal color progression, and delay in onset of sugar spots until at least color stage 7.

### Example 3.

In example 3, the effect of macro-perforated LDPE bag and micro-perforated LDPE bag packaging on the ripening and storability of green bananas was determined. Green banana fruits were packaged in commercially used macroperforated LDPE bags and in microperforated LDPE bags according to the invention, stored for 2 weeks at 58° F. to simulate actual transit conditions, and ripened with ethylene for an additional 4 days at 62° F. At color stage 3.5, the fruits were pulled out of storage and held at 68° F. for subsequent color progression, shelf life, and quality evaluations. Upon inspection, it was confirmed that LDPE bags according to the invention did not delay the ripening process to color stage 3.5, provided highly uniform ripening, extended the yellow life of the bananas, did not interfere with the usual taste and flavor quality of the bananas, caused the fruit to maintain higher firmness during storage post color stage 3.5, and led to 3 days of extension in shelf life of the bananas.

### Example 4.

In example 4, the effect of macro-perforated LDPE bag and micro-perforated LDPE bag packaging on the ripening and storability of green bananas was again determined under different conditions from example 3. Freshly harvested bananas were packaged in commercially used macroperforated LDPE bags (as controls), and microperforated LDPE bags according to the invention, in the country of production, packed in 3 and 4 layer cardboard boxes, shipped to Baltimore, Maryland in the United States, and ripened with ethylene through the bags and boxes for 4 days at 60° F. At color stage 3.5, the temperature of the room was adjusted to 70° F. to simulate supermarket and consumer conditions. The fruits were monitored for ripening and storability.

One batch of the fruits was pulled out of storage at color stage 3.5, transported to New Jersey, and held at 70° F. for subsequent color progression, shelf life, and quality evaluations. Upon inspection, it was confirmed that under semi-commercial conditions, the packaging and method according to the invention did not delay the ripening process to color stage 3.5, provided highly uniform ripening, extended the yellow life of the bananas, did not interfere with the usual taste and flavor quality of the bananas, maintained higher firmness during storage post color stage 3.5, led to 3 to 5 days of extension in shelf life of the bananas, and severely restricted the development of sugar spots after their onset.

### Example 5.

Example 5 illustrates the applicability of the invention to use for new commercial applications, such as the packaging and distribution of single bananas. In example 5, ethylene gassed single fingers of bananas weighing approximately 170 grams each were packaged individually in micro-perforated bags according to the invention and evaluated for storability over 6 days at 68° F. In a separate experiment, green single fingers of bananas weighing approximately 170 grams each were packaged individually in microperforated bags, held at 58° F. for 2 weeks to simulate actual transit conditions, ripened at 58° F. for 4 days with ethylene, and evaluated for storability over 6 days at 68° F. In both experiments, package atmospheres of 4.5% O₂ and 12% CO₂ were achieved on day 6 of holding at 68° F. The control unpackaged fingers developed sugar spots on day 3 of holding. In comparison, the microperforated bags according to the invention had the first signs of sugar spots on day 6 of holding. The ripening while delayed with microperforated packaging was highly uniform.

### Example 6.

Example 6 illustrates the applicability of the invention for consumer use. A consumer may purchase loose fruit from a supermarket or convenience store at a color stage greater than 3.5, close the fruit in the bag according to the invention, and experience the benefit of shelf life extension and thus reduce considerably the wastage of fruit due to quick quality deterioration at the consumer level.

Fruits from a local supermarket in New Jersey were purchased at color stage 5 and divided into two lots. The fruits of lot one were packed in bags according to the invention and held for 7 days. For comparison, the fruits of lot two were kept unpacked but also held for 7 days. The holding temperature was approximately 69° F.

While the unpacked fruits developed sugar spots on day 2 of holding, the fruits in the bags of the invention had no sugar spots until day 5 of holding. On day 6, sugar spots were noticeable on fruits packed in the bags of the invention. The further development of sugar spots was severely restricted and fruits stayed in an acceptable form throughout the 7 day holding period. This improved quality coupled with shelf life extension is of significant value to consumers of banana fruit. This example also demonstrates that this invention can also be extended to the packaging of gassed fruit. In that case, it is conceivable that fruit may be ripened under conventional methods and distributed or marketed in packages according to the invention.

### Example 7.

In example 7, freshly harvested green bananas again were packaged in units of 3 lbs. in the country of production, stored in standard 40 lb. cardboard boxes for 2 weeks at 58° F. to simulate actual transit conditions, and ripened with ethylene for 4 days at 62° F. At color stage 3.5, the fruits were pulled out of storage and held at 68° F. for subsequent color progression, shelf life, and quality evaluations.

The example on the left of the photograph shows the state of the fruit at day 6 of holding at 68° F. that was packaged in commercially used macroperforated bags. These fruits developed sugar spots on day 3 of holding at 68° F. By comparison, the example on the right of the photograph illustrates the benefit of the invention, showing no sugar spot development at day 6 of holding at 68° F. This clearly demonstrates an extension in shelf life of banana fruit by at least an additional three days, evidencing a significant benefit to the retailer.

Notably, using the package and method of packaging of the instant invention, bananas can be packed in units of 1-40 lbs. Single bananas can also be distributed in a similar manner for special marketing applications, such as the convenience store market. The package and method of the instant invention can also be used by consumers for extending the yellow life of bananas purchased as loose fruit from supermarkets, convenience stores or the like.

The package and method of the instant invention thus provide significant benefits over the prior art. More particularly, the banana fruit may be transported from their countries of production to the consuming markets of developed countries in a green, hard state to withstand the rigors of distribution and handling. Once the fruit reaches the destination country, it is ripened to color stage 3.5 before it could be marketed to supermarket chains and food service outlets. While fruits at supermarket shelves are displayed at color stage 3.5 and beyond, consumers prefer to eat fruit at color stages 5 to 6.5. In such a practice, banana fruits are delivered to the consumer in a non-preferred stage of ripeness. Consumers purchase fruit in clusters and each cluster may have 7 to 10 fruits. All the fruits in any given cluster ripen simultaneously and the expected shelf life is only 2 to 3 days at room temperature. Thus, consumers have a very limited time window to consume bananas at the consumer preferred stages of ripeness (color stages 5 to 6.5). On average, consumers eat 25% of the purchased banana fruit at the preferred stage of ripeness (5 to 6.5), 50% at non-preferred stages of ripeness (<5 or >6.5), and 25% are wasted. Eating banana fruit at non-preferred stages of ripeness (under-ripe or over-ripe) leads to consumer dissatisfaction that has a strong negative effect on its overall per capita consumption.

The invention set forth herein allows the retailer, food service purchaser or consumer to purchase and hold banana fruit at the preferred stage of ripeness for approximately 5-6 days. Since most of the consumers in the U.S. shop once a week, it is believed that the extension of shelf life of banana fruit by this invention will give consumers an opportunity to consume fruits at the preferred stages of ripeness throughout their shopping cycle. It is further believed that this will lead to improved consumer satisfaction, improved per capita consumption and reduced wastage at the supermarket and household levels.

Banana suppliers are constantly looking for ways to differentiate their product from the competition. New market offerings such as single serve bananas for club stores, consumer packages comprising of individual banana fingers (no clusters) for quick service restaurants, and new varieties are being viewed as product differentiating processes by major manufacturers and distributors in the banana trade. However, quality and shelf life issues have been the challenges thus far for commercializing these concepts. This invention helps to consistently deliver a good quality banana with improved shelf life in the marketplace and thus should help the banana companies in product differentiation and eventually brand recognition.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A perishable food product package comprising:
a package having two sidewalls, a closed bottom edge and two closed side edges, each of said closed edges joining a respective edge of each sidewall to a corresponding edge of the other of said sidewalls, said package having a plurality of perforations extending through at least one of said sidewalls, said perforations being sized and provided in sufficient density to allow respiration of a perishable food product packaged within said package to maintain a packaged atmosphere inside of said package when closed with such perishable food product therein of <10% O₂, 5-20% CO₂, and relative humidity of >70% during at least a portion of the ripening, distribution, or storage processes of said perishable food product.

2. The perishable food product package of claim 1, said perforations further being configured to allow passage of a ripening agent through said package.

3. The perishable food product package of claim 1, wherein said perforations have a diameter of 5-500μ, and said perforations are present at a density of 11-100 perforations per pound of food product intended to be packaged in said package.

4. The perishable food product package of claim 1, wherein said perforations have a mean diameter of 100-130μ.

5. The perishable food product package of claim 1, wherein said package is formed of a polymeric film.

6. The perishable food product package of claim 5, wherein said polymeric film comprises a compound selected from the group consisting of polyalkenes, polyvinyls, polystyrenes, polysiloxanes, polydiens, and laminates of any combination of the foregoing.

7. The perishable food product package of claim 1, wherein said package is formed of flexible packaging material selected from the group consisting of low density polyethylene, ultra low density polyethylene, linear low density polyethylene, high density polyethylene, cast polypropylene, bioriented polypropylene, polyvinyl chloride, sealable polyester and styrene butadiene, and with or without antifog agents.

8. The perishable food product package of claim 1, wherein each sidewall of said package has a thickness of >8μ.

9. A method of packaging a perishable food product, comprising:
providing a package having two sidewalls, a closed bottom edge and two closed side edges, each of said closed edges joining a respective edge of each sidewall to a corresponding edge of the other of said sidewalls, said package having a plurality of perforations extending through at least one of said sidewalls, said perforations being sized and provided in sufficient density to allow respiration of a perishable food product packaged within said package to maintain a packaged atmosphere inside of said package when closed with such perishable food product therein of <10% O₂, 5-20% CO₂, and relative humidity of >70% during at least a portion of the ripening process of said perishable food product;
packaging said perishable food product in said package and closing said package;
ripening said perishable food product through exogenous application of a ripening agent at 56 to 64° F. to an intermediate ripening stage; and
thereafter distributing said perishable food product while maintaining said perishable food product in said package so as to maintain an environment inside said package comprising greater than 2% O₂ and greater than 10% CO₂.

10. The method of claim 9, said packaging step further comprising closing said package such that the environment within said package comprises ambient atmosphere.

11. The method of claim 9, said packaging step further comprising closing said package such that the environment within said package comprises predetermined levels of O₂, CO₂, and N₂.

12. The method of claim 9, further comprising the step of selecting a size and density of said perforations depending upon a weight of perishable food product within said package.

13. The method of claim 9, wherein said perishable food product comprises fruit from one or more climacteric crops.

14. The method of claim 13, wherein said fruit comprises bananas.

15. The method of claim 14, wherein said step of maintaining an environment inside said package comprising greater than 2% O₂ and greater than 10% CO₂ further comprises allowing said bananas to progress beyond color stage 3.5 while maintaining uniform color and sensory attributes of the bananas and delaying onset of sugar spot development.

16. A method of extending the shelf life of bananas, comprising:
selecting a package having a predetermined size and density of perforations, said predetermined size and density being based upon a weight of bananas intended to be packaged in such package, to allow respiration of the packaged bananas to maintain a predetermined atmosphere within said package such that ripening of said bananas to color stage 3.5 proceeds without appreciable delay, but ripening of said bananas beyond color stage 3.5 is extended.

17. The method of claim 16, wherein said predetermined atmosphere within said package comprises greater than 5% O₂ and less than 12% CO₂ prior to color stage 3.5.

18. The method of claim 16, wherein said predetermined atmosphere within said package comprises <5% O₂ and 5-20% CO₂ beyond color stage 3.5.

19. The method of claim 16, wherein said predetermined atmosphere within said package comprises O₂ and CO₂, and wherein the ratio of CO₂:O₂ present in said atmosphere beyond color stage 3.5 comprises 2.5:1 to 3.5:1.

20. A method of packaging a perishable food product, comprising:
providing a package having two sidewalls, a closed bottom edge and two closed side edges, each of said closed edges joining a respective edge of each sidewall to a corresponding edge of the other of said sidewalls, said package having a plurality of perforations extending through at least one of said sidewalls, said perforations being sized and provided in sufficient density to allow respiration of a perishable food product packaged within said package to maintain a packaged atmosphere inside of said package when closed with such perishable food product therein of greater than 2% O₂ and greater than 5% CO₂; and
packaging said perishable food product in said package and closing said package.

21. The method of claim 20, wherein said perishable food product comprises a climacteric fruit.

22. The method of claim 21, said packaging step occurring after said climacteric fruit has ripened to an intermediate stage suitable for commercial distribution of said climacteric fruit.

23. The method of claim 20, wherein said perishable food product comprises one or more bananas.

24. The method of claim 23, said packaging step occurring after said bananas have ripened to color stage 3.5.
